(19) United States
(12) Patent Application Publication
(10) Pub. No.: US 2012/0022446 A1
(43) Pub. Date: Jan. 26, 2012

(54) ORAL FLUID DELIVERY DEVICE

(75) Inventors: Sandhya Desai, Plymouth Meeting, PA (US); Deepu Sasidharan, Westminster, CO (US); Jimmy Garrey, Fountain Valley, CA (US)

(73) Assignee: EARTHLING, LLC, Westminster, CO (US)

(21) Appl. No.: 13/187,806

(22) Filed: Jul. 21, 2011

Related U.S. Application Data
(60) Provisional application No. 61/366,334, filed on Jul. 21, 2010.
(60) Provisional application No. 61/445,418, filed on Feb. 22, 2011.

(51) Int. Cl. A61J 7/00; B23P 17/04; B65D 85/00

(52) U.S. Cl. 604/77; 206/438; 29/527.1

(57) ABSTRACT

An oral fluid delivery device is provided with a body having a base and a nipple extending from the base. At least one channel projects through the nipple. A fluid reservoir has a proximal end that is secured to the base to form an integrated unit, and a distal end with a vent hole formed therethrough for equalizing pressure within the fluid reservoir. A valve is disposed between the fluid reservoir and the channel for restricting fluid flow through the channel. A piston may be disposed within the fluid reservoir and adapted for translating relative to the base corresponding to the amount of fluid contained within the fluid reservoir.

### CROSS-REFERENCE TO RELATED APPLICATIONS

This application claims the benefit of U.S. provisional Application No. 61/366,334 filed Jul. 21, 2010 and U.S. provisional Application No. 61/445,418 filed Oct. 20, 2010, the disclosures of which are incorporated in their entirety by reference herein.

### TECHNICAL FIELD

The disclosed concepts relate to devices which aid in the oral administration of a fluid.

### BACKGROUND

Over time devices have been constructed to aid in the delivery of fluids orally to humans and animals for a variety of reasons. Often fluids are utilized as a medium to deliver therapeutics, supplements and medications. A known method of delivery of supplements and medications to a child, primarily to an infant or toddler, has been through oral administration of a fluid. As examples, supplements have been added to milk in a child's bottle, and liquid prescription medications have been administered through oral syringes. None of these methods, however, have allowed for a controlled metering of the fluid for an extended duration of time.

In some situations, fluids such as sedatives and antihistamines have been orally administered to children to help calm infants in stressful environments as flying in airplanes or while attending religious services. There is a need for an oral delivery device that soothes the user and automatically controls the dispensing time for an extended period of time to allow the internal or environmental stressors to pass.

### SUMMARY

In one embodiment, an oral fluid delivery device is provided with a body having a base and a nipple extending from the base. At least one channel projects through the nipple. A fluid reservoir has a proximal end that is secured to the base to form an integrated unit. A valve is disposed between the fluid reservoir and the channel for restricting fluid flow through the channel.

In another embodiment, a pacifier is provided with a body having a base and a nipple extending from the base. At least one channel projects through the nipple. A fluid reservoir has a proximal end that is secured to the base to form an integrated unit, and a distal end with a vent hole formed therethrough for equalizing pressure within the fluid reservoir. The fluid reservoir is in fluid communication with the at least one channel. A piston is disposed within the fluid reservoir and adapted for translating relative to the base corresponding to the amount of fluid contained within the fluid reservoir.

In yet another embodiment, a method for assembling a pacifier is provided. A fluid reservoir is provided with a proximal end with an opening formed therethrough. A valve is disposed over the fluid reservoir opening. And a body, having a base and a nipple, is molded over the fluid reservoir to form an integrated unit without any removable components.

In still yet another embodiment of the present invention involves a pre-filled oral fluid delivery device comprising a sweetener. The oral fluid delivery device allows a caregiver to quickly reach into their bag, open a package, rupture a seal, and place a pre filled pacifier containing a sweetener solution fluid into the mouth of an infant/toddler for calming. For example, during the administration of vaccines, a caregiver could quickly place a pre filled pacifier into the infant's mouth to provide comfort and pain relief for the duration of the vaccination. Similarly on an airplane flight, if an infant was experiencing stress due to the environment, the often equally stressed caregiver could conveniently provide a pacifier containing a sweetener fluid to the infant to provide comfort and calming for the entire duration of the take-off.

The pre-filled pacifier could also include a fluid with a medication. In this embodiment, the nipple member of the pacifier is connected to a fluid reservoir in the base member of the pacifier via a passive valve mechanism and a frangible seal or a piston mechanism. The frangible seal is ruptured by twisting the base member or device. However, other embodiments may include a piercing button to rupture the seal, or other ways to impart a force on the seal, such as pulling, pushing or squeezing the nipple. Once the frangible seal is broken, the fluid will travel through the passive valve mechanism to the surface of the nipple member due to the capillary forces. The fluid will flow out of the nipple member when there is sufficient suction applied on the outer surface of the nipple member. The flow is metered (e.g., slowed) by the flow resistance in the passive valve mechanism. In another embodiment, the frangible seal could be avoided by utilizing a piston mechanism within the fluid reservoir, which would also prevent air from being swallowed by the infant, but would still allow for flow when there is sufficient suction applied on the outer surface.

In another embodiment, a nipple with a passive valve mechanism control is used on a conventional bottle, cup, or syringe holding a fluid to meter (e.g., slow or decrease) the rate at which a fluid is orally administered. The bottle, cup or syringe may hold fluids such as, but not limited to, milk or formula, water, juice, soda, a sweetener solution, a therapeutic in a fluid, a supplement in a fluid, a medication in a fluid, or any combination thereof. Moreover the nipple could be used with other containers.

In an alternative embodiment, the fluid reservoir, cup, bottle, or syringe, as well as the piston or frangible seal may be avoided by simply filling the passive valve mechanism with the fluid. In at least one embodiment the oral fluid delivery device is a pacifier with a venturi meter, such as an orifice plate or plurality of channels pre-filled with the fluid to be orally administered. In this embodiment the fluid is maintained in fluid reservoir or the channels by an exterior seal over the reservoir or channel openings.

In the case of administering a fluid orally for the purposes of calming or alleviating pain in an infant, a relatively prolonged duration of fluid administration is desired. In some embodiments, a venturi meter, microchannels, honeycomb, or sponge like structures within the nipple body of the administration device can act as a passive valve mechanism and operate to prolong the administration time by 175% to 500% when compared to typical baby nipples, and in other embodiments by more than 200% to 425% when compared to typical baby nipples, and in yet other embodiments by more than 250% to 300% when compared to typical baby nipples. Thus, the oral administration of the fluid utilizing the present invention would aid in the calming of a child during situations such as, but not limited to, a circumcision or IV line placement in a hospital, an airplane landing, or a wedding ceremony.

The flow through the passive valve mechanism may be optimized for various age groups or medical needs based on diameter, length, and number of microchannels, the density of the honeycomb or sponge-like structure, or the characteristics of the venturi meter, including altering the diameter of the throat of the meter or the angles of the conical pipes making up the venturi meter. The microchannels, honeycomb, sponge-like structures, or venturi meter may also be optimized for flow based on the viscosity and properties of the fluid within the nipple member, cup, pacifier reservoir or bottle.

In embodiments where the fluid reservoir is directly connected to the nipple body, the reservoir can empty as the baby sucks on the nipple, and the infant's sucking action would allow a piston to gradually drop further into the reservoir. This passive mechanism of the piston dropping into the reservoir would reduce the potential for the infant to swallow air when the reservoir is empty.

In still yet another embodiment, the nipple could contain a removable compartment. For an infant or adult with a medical condition that requires regular usage of the nipple, the nipple could hold a removable compartment containing the fluid reservoir and frangible seal or the fluid reservoir with piston. This would allow an empty fluid reservoir to be removed and discarded, and replacement fluid reservoir to be reinserted. This cartridge style replacement of pre-filled fluid reservoirs would allow the nipple to be reused with an easy filling operation. In another embodiment the removable compartment could contain the fluid reservoir and frangible seal, or the fluid reservoir with piston, but could also contain the microchannels, honeycomb, sponge-like structure, or venturi meter or other flow control devices as well. This cartridge-style replacement of pre-filled reservoirs could allow the nipple to be reused with an easy filling operation.

As an additional embodiment, a filter can be used in situations where a large number of particulates are in the fluid in order to prevent clogging of the passive valve mechanism. In the event that the fluid being delivered contains particulates, it is possible to utilize a filter between the reservoir, cup, bottle, or syringe holding the fluid and the nipple member containing the passive valve mechanism. The filter can block particulates that could clog the channels or passages in the passive valve mechanism during fluid administration.

The passive valve control of the invention may also eliminate issues resulting in fluid splashing. Prior art devices administer fluids directly from the reservoir with no passive valve control. This method of fluid delivery involves a higher uncontrolled flow rate, which is subject to splashing within the reservoir. Splashing, which can occur during any sudden movement, such as drinking while in a stroller, car or shopping cart, causes the fluid flow to increase. Splashing can be dangerous for infants, as the infant can unexpectedly get the fluid too quickly, potentially resulting in choking. Splashing can increase the flow rate within a nipple significantly more than the intended flow rate, thus converting a stage “zero” nipple to a stage “two” nipple, which would generally be indicated for a 7 month old infant, rather than a newborn infant. The passive valve control of the invention meters the flow to a constant flow rate unaffected by fluid splashing. Thus, the impact of splashing can be substantial on choking, and the passive valve mechanism of the invention can reduce the potential complications of splashing. Therefore, the use of a valve such as a venturi meter, microchannels, a honeycomb or sponge-like structure within any nipple can not only prolong the delivery of fluid and reduce splashing within a pacifier but also when connected to a bottle or other vessel.

Other potential benefits of a more controlled delivery system within a nipple may be its use as a therapeutic tool in infants and even adults with swallowing problems due to an underlying medical condition. For example, such a controlled delivery system within a nipple may be useful for infants that are transitioning from a thickened feed to a normal infant fluid diet. Also some therapies in infants with swallowing dysfunction are directed toward strengthening of swallowing musculature, which the disclosed concept could allow due to increased resistance during the sucking action. Additionally these patients are even more susceptible to the complications of splashing, including aspiration and potential resulting pneumonias. In the elderly, there are some individuals who have poor coordination of swallowing following cerebral ischemia/stroke or secondary to dementia and this oral delivery device concept may be attached to a cup or bottle and utilized to protect them from aspiration.

### BRIEF DESCRIPTION OF THE DRAWINGS

FIG. 1 is a side perspective view of an oral fluid delivery device according to at least one embodiment;

FIG. 2 is another side perspective view of the device of FIG. 1, illustrated with an exemplary packaging assembly in exploded view;

FIG. 3 is a partial section view of the device and packaging assembly of FIG. 2, taken along section line 3-3, and illustrated in an assembled position;

FIG. 4 is an enlarged exploded view of a fluid dispensing subassembly of the device of FIG. 1;

FIG. 5 is an exploded view of the device of FIG. 1;

FIG. 6 is another partial section view of the device of FIG. 2, illustrated with a piston in a distal position;

FIG. 7 is yet another partial section view of the device of FIG. 2, illustrated with the piston in an intermediate position;

FIG. 8 is a section view of an oral fluid delivery device according to another embodiment;

FIG. 9 is a perspective view of the device of FIG. 8 illustrated with a removable seal;

FIG. 10 is a side perspective view of an oral fluid delivery device according to yet another embodiment, illustrated attached to a bottle; and

FIG. 11 is a side perspective view of an oral fluid delivery device according to still yet another embodiment, illustrated with a removable plurality of channels.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Except in the examples, or where otherwise expressly indicated, all numerical quantities in this description indicating amounts of material are to be understood as modified by the word “about” in describing the broadest scope of the invention. Practice within the numerical limits stated is generally preferred. Also, unless expressly stated to the contrary: the description of a group or class of materials as suitable or preferred for a given purpose in connection with the invention implies that mixtures of any two or more of the members of the group or class are equally suitable or preferred; and, unless expressly stated to the contrary, measurement of a property is determined by the same technique as previously or later referenced for the same property.

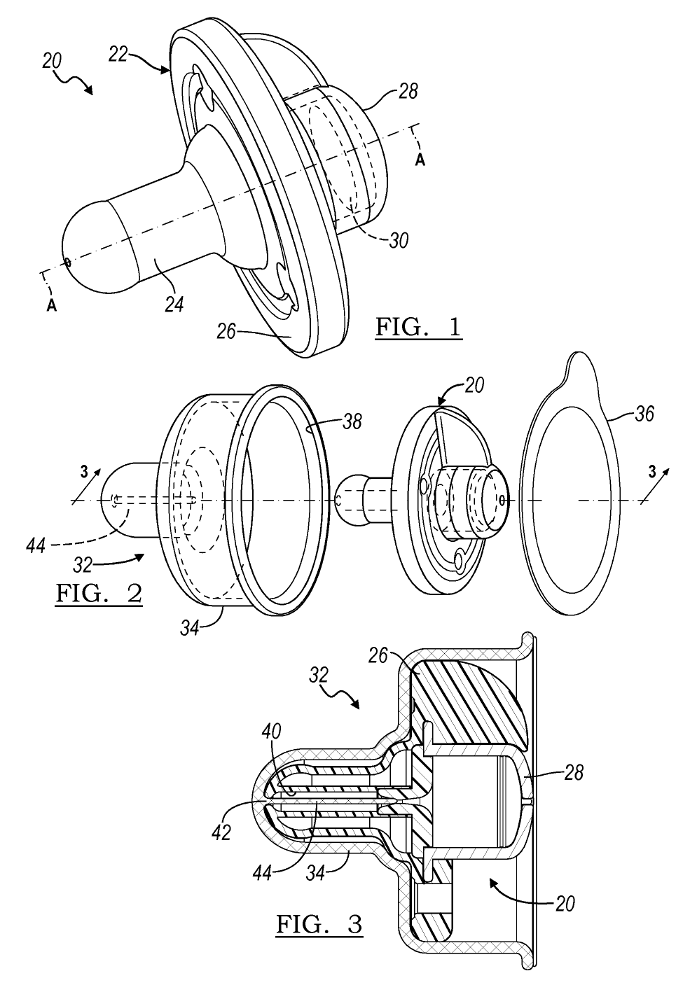

With reference to FIG. 1, an oral fluid delivery device is illustrated in accordance with an embodiment and is referenced by numeral 20. The illustrated embodiment depicts the device 20 as a pacifier having internal fluid and a valve for restricting fluid flow from the device 20 and thereby providing a relatively prolonged and controlled dispensing time of the fluid.

The oral fluid delivery device 20 includes a body 22 having a nipple 24 and a base 26. The nipple 24 extends outward from the base 26 along a central axis A-A. A fluid reservoir 28 is attached to the base 26, and extends outward from the base 26 in an opposite direction as the nipple 24. The body 22 may be formed from any number of flexible materials, such as natural and synthetic polymers or silicone. For instance, the body 22 may be formed from natural polymers including but not limited to natural rubbers, and polyisoprene. Also, the body 22 may be formed from a variety of thermoset, thermoplastic, or UV initiated polymers including but not limited to silicone, polyurethane, polyvinyl chloride, latex, and synthetic polyisoprene.

The oral fluid delivery device 20 is pre-filled with a sweetener, according to one embodiment. A fluid 30, such as a solution of sucrose and water is disposed within the fluid reservoir 28. The device 20 allows a caregiver to quickly reach into their bag, open a package and place the pre-filled device 20 containing a sweetener solution (fluid 30) into the mouth of an infant/toddler for calming. For example, during the administration of vaccines, a caregiver could quickly place the pre-filled device 20 into the infant's mouth to provide comfort and pain relief for the duration of the vaccination. Similarly on an airplane flight, if an infant was experiencing stress due to the environment, the often equally stressed caregiver could conveniently provide a device 20 containing the sweetener fluid 30 to the infant to provide comfort and calming for the entire duration of the take-off. Alternatively, the device 20 may include a liquid medication 30, or other fluids 30 as desired.

The device 20 includes a small fluid reservoir 28. The illustrated embodiment depicts a fluid reservoir 28 sized to hold up to approximately 2.0 milliliters of fluid 30. Another embodiment of the device 20 is configured for pre-mature infants, and includes a fluid reservoir 28 for holding up to 0.5 milliliters of fluid 30. Other embodiments of the device 20 are contemplated for holding between 0.5 and 5.0 milliliters of fluid 30, and in yet other embodiments between 1.0 and 4.0 milliliters of fluid 30.

Referring to FIGS. 2 and 3, the device 20 is enclosed within a packaging assembly 32 according to one embodiment. The packaging assembly 32 helps to keep the device 20 clean prior to use. The packaging assembly 32 includes a receptacle 34 and a lid 36. The receptacle 34 may be contoured, as shown in the illustrated embodiment, to orient the device 20. The lid 36 is disposed over an opening 38 formed in the receptacle 34. The lid 36 may be formed of a foil material and attached to the receptacle 34 by an adhesive. The lid 36 may also include a tab that extends radially outward to provide a handle for the caregiver to grasp during removal.

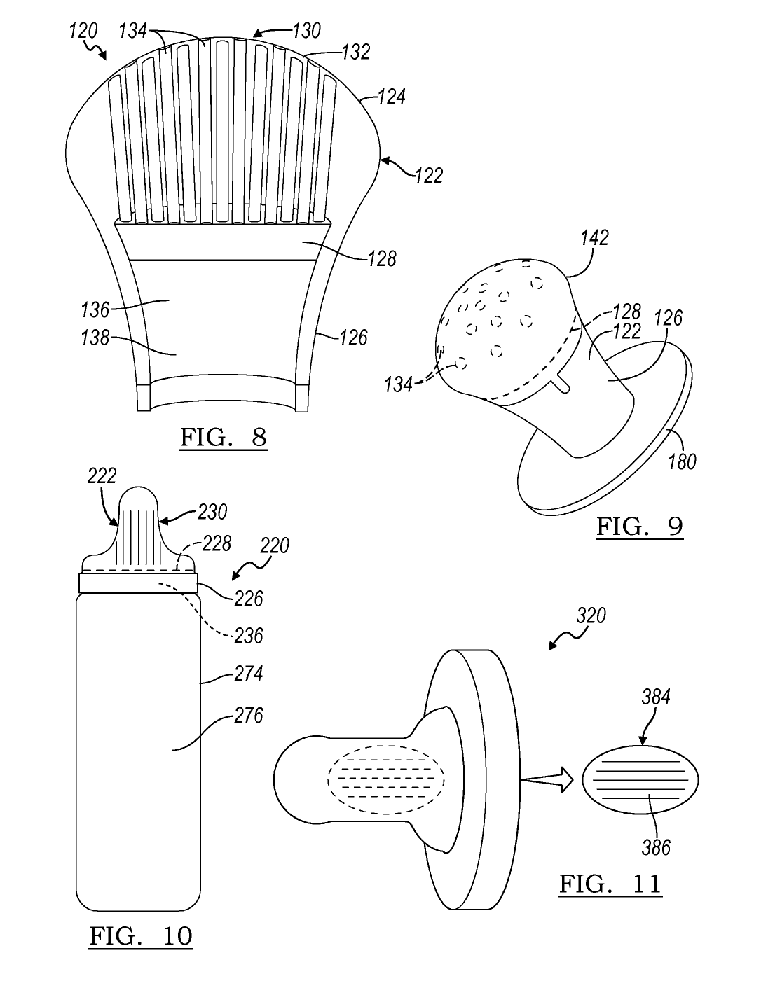

With reference to FIG. 3, a channel 40 is formed in the body 22 and provides a passageway for fluid to travel through the device 20. In one embodiment, the device 20 includes a single channel 40 that projects through the nipple 24, between the fluid reservoir 28 and an opening 42 formed in a distal end of the nipple 24. Other embodiments of the device 20 include multiple channels (shown in FIG. 8).

In at least one of the illustrated embodiments, the packaging assembly 32 includes an elongate protrusion 44 to prevent passive drainage of the fluid 30 from the device 20. The protrusion 44 extends from a distal end of the receptacle 34 along the central axis A-A. The protrusion 44 extends into the channel 40. In the illustrated embodiment, the protrusion 44 extends substantially through the channel 40 toward the base 26. In other embodiments, the protrusion 44 extends only partially through the channel 40 (not shown). The protrusion 44 engages the nipple 24 about the nipple opening 42 to prevent passive drainage from the device 20, therefore the length of the protrusion 44 beyond the opening 42 may be altered as desired.

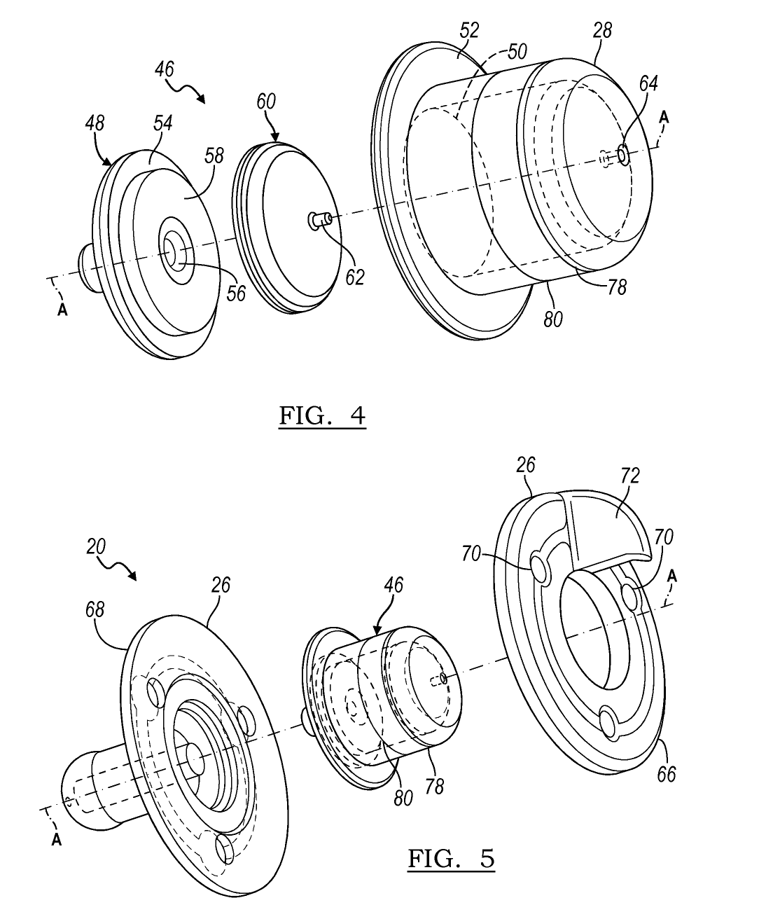

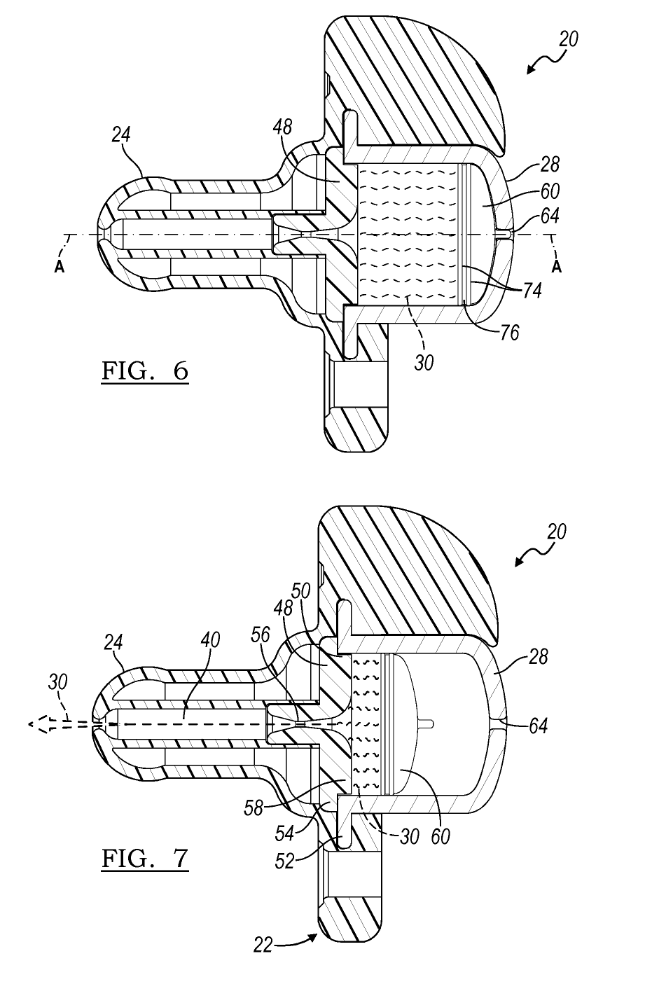

FIG. 4 depicts an exploded view of an exemplary fluid dispensing subassembly 46. The illustrated fluid dispensing subassembly 46 includes the fluid reservoir 28 and a valve 48. The fluid reservoir 28 can have any suitable size and shape. However, in the illustrated embodiment the fluid reservoir 28 is formed in a generally cylindrical shape with an opening 50 formed in the proximal end. A flange 52 extends radially outward from the proximal end. The valve 48 of the illustrated embodiment includes a base 54 with an aperture 56 formed through a central portion of the base 54. The valve 48 includes a boss 58 that extends axially from the base 54 and is received within the fluid reservoir 28 (as shown in FIG. 6). In one embodiment, the valve 48 is secured to the fluid reservoir 28 by ultrasonically welding an outer peripheral portion of the valve base 54 to the fluid reservoir flange 52. However, it should be understood that the valve 48 and the fluid reservoir 28 can be secured to each other in any suitable manner. The fluid dispensing subassembly 46 also includes a piston 60 that is enclosed within the fluid reservoir 28. The piston 60 of the illustrated embodiment is generally disc shaped, and is adapted to translate axially along the length of the fluid reservoir 28. In one embodiment, a plug 62 extends axially from a central portion of the piston 60 and is sized to be received by a vent hole 64 formed in a distal end of the fluid reservoir 28. In another embodiment, the plug 62 extends through the vent hole 64 (not shown), such that the caregiver may depress the plug 62 to manually translate the piston 60 and thereby control the flow rate of the fluid 30 from the device 20. In other embodiments, the piston 60 is provided without the plug 62.

FIG. 5 illustrates an exploded view of the illustrated oral fluid delivery device 20. The device 20 may be formed by molding the body 22 over the fluid dispensing subassembly 46. Alternatively, the body 22 may include two separate pieces: a top 66 and a bottom 68, that are attached to each other to secure the fluid dispensing subassembly 46 between the top 66 and bottom 68. A series of apertures 70 are formed through the base 26 and help ensure air circulation to the user while using the device 20. The body 22 may also include a handle 72 that extends axially from a peripheral portion of the base 26 and adjacent to the fluid reservoir 28. The handle 72 provides a location for grasping the device 20, without contacting the nipple 24.

FIGS. 6 and 7 illustrate the flow of the fluid 30 from the device 20. Once the device 20 is removed from the packaging assembly 32 (shown in FIG. 3), the protrusion 44 is removed from the channel 40 and the fluid 30 will flow out of the nipple opening 42 when there is sufficient suction applied to the nipple 24.

The valve 48 is disposed over the fluid reservoir opening 50 for restricting fluid flow through the device 20. The valve 48 functions as a passive valve, such as a venturi meter or orifice plate, due to the relatively small size of the valve aperture 56. The valve 48 allows fluid 30 to flow from the device 20 by capillary forces and inhibits the fluid 30 from draining from the device 20 unless sufficient suction is applied to the nipple 24. By restricting the fluid flow, the device 20 prolongs the time to fully administer the fluid 30 to the user.

The device 20 is configured for dispensing all of the fluid 30 from the fluid reservoir 28 in at least nine minutes according to at least one embodiment, and in nine to eleven minutes, according to other embodiments. The valve aperture 56 is between 0.5 and 0.7 mm in diameter, and the fluid reservoir 28 contains between 0.5 and 5.0 ml of an at least 24% sucrose solution 30. Commercially available prior art nipples (not shown) are configured to dispense approximately 3.0 ml of fluid in six seconds to three minutes. Therefore in at least one embodiment of the device 20, the typical time to fully administer the fluid 30 to the user would be extended by at least at least two hundred percent (six minutes) over the prior art. The viscosity of the fluid 30 affects the flow rate. Therefore the size of the valve aperture 56 may be adjusted to maintain the desired dispensing time, or flow rate, for fluids 30 of varying viscosity.

For example, in one embodiment of the device 20, the valve aperture 56 is between 0.5 and 0.7 mm in diameter. The fluid reservoir 28 contains approximately 2.0 ml of a 24% sucrose solution (fluid 30). When the nipple 24 is subjected to a relatively constant 15.5 mm Hg (0.3 psi) suction, the fluid 30 flows at a rate of approximately 0.18 ml/minute, to dispense the 2.0 ml of fluid 30 in approximately eleven minutes. The ratio of fluid 30 within the fluid reservoir 28 in milliliters to flow rate through the valve in milliliters per minute is approximately 1:0.09.

In another example, the valve aperture 56 is between 0.5 and 0.7 mm in diameter. The fluid reservoir 28 contains approximately 2.0 ml of a 24% sucrose solution (fluid 30). When the nipple 24 is subjected to a relatively constant 15.5 mm Hg (0.3 psi) suction, the fluid 30 flows at a rate of approximately 0.22 ml/minute, to dispense the 2.0 ml of fluid in approximately nine minutes. The ratio of fluid 30 within the fluid reservoir 28 in milliliters to flow rate through the valve in milliliters per minute is approximately 1:0.11.

In yet another example, the valve aperture 56 is between 0.5 and 0.7 mm in diameter. The fluid reservoir 28 contains approximately 5.0 ml of a 24% sucrose solution (fluid 30). When the nipple 24 is subjected to a relatively constant 15.5 mm Hg (0.3 psi) suction, the fluid 30 flows at a rate of approximately 0.56 ml/minute, to dispense the 2.0 ml of fluid in approximately nine minutes. The ratio of fluid 30 within the fluid reservoir 28 in milliliters to flow rate through the valve in milliliters per minute is approximately 1:0.11.

In still yet another example, the valve aperture 56 is between 0.5 and 0.7 mm in diameter. The fluid reservoir 28 contains approximately 0.5 ml of a 24% sucrose solution (fluid 30). When the nipple 24 is subjected to a relatively constant 15.5 mm Hg (0.3 psi) suction, the fluid 30 flows at a rate of approximately 0.05 ml/minute, to dispense the 0.5 ml of fluid in approximately eleven minutes. The ratio of fluid 30 within the fluid reservoir 28 in milliliters to flow rate through the valve in milliliters per minute is approximately 1:0.09.

A common problem with prior art oral fluid delivery devices is that as fluid is dispensed from the device, a low pressure void (“negative pressure”) develops in the fluid reservoir. This low pressure void increases the suction pressure needed to remove the remaining fluid. Once the user releases the nipple, air may be drawn into the fluid reservoir to equalize the internal pressure. This air is later ingested by the infant with the remaining fluid and results in indigestion (“gas”).

In one embodiment, the device 20 is configured for maintaining a generally constant pressure within the fluid reservoir 28 which prevents negative pressure from developing. The piston 60 is disposed within the fluid reservoir 28 and is translatable along axis A-A. The fluid 30 is generally constrained between the piston 60 and valve 48, and the piston 60 translates corresponding to the amount of fluid 30 within the reservoir 28. The vent hole 64 is formed in the distal end of the fluid reservoir 28. FIG. 6 schematically depicts an oral fluid delivery device 20 prior to use, where the fluid reservoir 28 is essentially full with fluid 30 and the piston 60 is located at the distal end of the fluid reservoir 28. As suction is applied to the nipple 24 during use, the fluid 30 is drawn from the fluid reservoir 28 and through the channel 40 as shown in FIG. 7. As fluid 30 exits the device 20, the piston 60 translates axially toward the valve 48 to maintain a generally constant pressure within the proximal end of the fluid reservoir 28 (between the piston 60 and the valve 48). The vent hole 64 allows air to enter the distal end of the fluid reservoir 28 as the piston 60 translates, to maintain a generally constant pressure within the distal end of the fluid reservoir 28 (between the piston 60 and vent hole 64).

The piston 60 engages an inner periphery of the fluid reservoir 28 to form a seal. This seal prevents the fluid 30 from leaking out of the vent hole 64 in the distal end of the fluid reservoir 28. This seal also prevents air that enters the device 20 through the vent hole 64 from reaching the fluid 30. In one embodiment, two o-rings 74 are attached to an outer periphery of the piston 60 for engaging the inner periphery of the fluid reservoir 28 and forming the seal. In another embodiment of the device 20, a wiper seal (not shown) is attached to an outer periphery of the piston 60. Alternatively the wiper seal may be integrally formed with the piston 60.

In at least one embodiment, the oral fluid delivery device 20 includes a transparent or translucent fluid reservoir 28, which would allow the caregiver to know when the reservoir 28 is empty. In one embodiment, the device 20 includes an indicator band 76 for indicating the amount of fluid 30 remaining in the fluid reservoir 28. The band 76 is attached to the piston 60 between the o-rings 74, as shown in the illustrated embodiment. The indicator band 76 is of a contrasting color as that of the piston 60, so that the indicator band 76 is visible through the reservoir 28. For example, in one embodiment the band 76 is red and the piston 60 is black. Additionally, the fluid reservoir 28 includes markings 78, 80 (shown in FIGS. 4 and 5) that indicate different volumes of fluid 30 within the fluid reservoir 28. In the illustrated embodiment the fluid reservoir 28 includes two markings: a distal marking 78 which represents a full reservoir 28, and a proximal marking 80 which represents an empty reservoir 28. Other embodiments of the fluid reservoir 28 include a series of markings (not shown) that are indicative of specific volumes, similar to markings on a measuring cup. Other embodiments of the device 20 contemplate adding coloring to the fluid 30 to make the level of the fluid 30 more noticeable.

The oral fluid delivery device 20 is configured as a disposable device according to one embodiment. Oral devices develop bacteria over time as saliva on the device reacts with the fluid. Therefore oral devices must be properly cleaned if they are to be reused.

The American Academy of Pediatrics recommends pacifiers that are formed as a single unit, and without any removable components. Removable components present choking hazards to young children. Traditional pacifiers do not include internal fluid and many do not include removable components. However, many prior art oral devices (e.g., pacifiers) that include internal fluid also include removable components so that the pacifier may be cleaned and reused.

The oral fluid delivery device 20 is assembled as an integral assembly, without any removable components according to one embodiment. The valve base 54 abuts the fluid reservoir flange 52, and the valve boss 58 extends axially from the base 54 and into the fluid reservoir 28. The valve 48 engages the proximal end of the fluid reservoir 28 with an interference fit in one embodiment. Alternatively, the valve 48 may be ultrasonically welded to the fluid reservoir 28. The body 22 is molded over the proximal end of the fluid reservoir 28, including the valve 48. After the body 22 is molded, the fluid 30 is injected into the fluid reservoir 28 using a positive displacement method, where a needle (not shown) is inserted into the channel 40. By forming the device 20 as an integral assembly, the device 20 does not include any removable components and therefore limits the choking risk to children.

With reference to FIGS. 8 and 9, an oral fluid delivery device is illustrated in accordance with an embodiment and is referenced by numeral 120. The device 120 includes a nipple body 122 with a first section 124, a second section 126 and a frangible seal 128 disposed within the nipple body 122 between the first section 124 and the second section 126. The first section 124 defines a plurality of channels 130 and has an outer surface 132, which defines openings 134 for the plurality of channels 130. The plurality channels 130 function as a passive valve mechanism, due to the relatively small inner diameter of each channel 130, similar to the valve 48 of FIGS. 1-7. Once the frangible seal 128 is broken, the fluid will travel through the channels 130 to the surface of the first section 124 of the nipple body 122 due to the capillary forces. The fluid will flow out of the nipple body 122 when there is sufficient suction applied on the outer surface of the first section 124.

In one embodiment, the second section 126 and frangible seal 128 cooperate to define a fluid reservoir 136. In another embodiment, the frangible seal 128 is a capsule having fluid therein. The frangible seal 128 is rupturable to enable the openings 134 of the plurality of channels 130 to be in fluid communication with the fluid reservoir 136 upon rupture of the frangible seal 128. While frangible seal 128 is shown in its location between reservoir 136 and the plurality of channels 130, it could be located anywhere in the nipple body 122, even in the plurality of channels 130. Furthermore, the frangible seal 128 and fluid reservoir could alternatively be in the pacifier body (not shown) rather than the nipple body 122. While a plurality of openings 134 are illustrated and described, it should be understood that only one opening could be provided. For instance, the nipple body 122 could have only one opening (or fewer openings than the number of channels) with the channels flowing into the one opening (or fewer openings).

The nipple body 122 may be formed from any number of flexible materials, such as natural and synthetic polymers or silicone. For instance, the nipple body 122 may be formed from natural polymers including but not limited to natural rubbers, and polyisoprene. Also, nipple body 122 may be formed from a variety of thermoset, thermoplastic, or UV initiated polymers including but not limited to silicone, polyurethane, polyvinyl chloride, latex, and synthetic polyisoprene.

In one embodiment, the oral fluid delivery device 120 holds a fluid 138 disposed within the fluid reservoir 136 in which the fluid 138 is a solution comprising a sweetener. As an example, the fluid 138 disposed within the fluid reservoir 136 is a sweetener consisting of a 10%-50% sucrose solution. Another example would be an oral fluid delivery device 120 with fluid 138 in the fluid reservoir 136 that is a sweetener consisting of a 20%-30% sucrose solution. Other embodiments of the device 120 contain a fluid 138 solution containing sweeteners such as, but not limited to, fructose, dextrose, sucrose, or any combination thereof. For instance, in certain other instances, the sweetener may be greater than 24% of the solution in the oral fluid delivery device.

In another embodiment, the oral fluid delivery device 120 holds a fluid 138 disposed within the fluid reservoir 136 in which the fluid 138 contains a medicant. Fluid 138 may contain medicants such as, but not limited to, an antimicrobial, an antipyretic, a vitamin, a vaccine, a herbal extract or remedy, or any combination thereof.

In yet another embodiment of an oral fluid delivery device 120, a particulate filter (not shown) is disposed within the nipple body 122 between the plurality of channels 130 and the fluid reservoir 136. The particulate filter is used to prevent clogging of the plurality of channels 130 or the passage within the main channel of a valve, such as a venturi meter (shown in FIG. 4) in the event that fluid 138 used in the fluid reservoir 136 contains a significant amount of particulates. The filter 40-mesh size is smaller than the diameter of the plurality of channels 130 or the main channel of the venturi meter to keep particulates that could clog the channels out of the channels.

Referring to FIG. 9, a removable seal 142 is partially disposed about the nipple body 122. The nipple body 122 defines openings 134 of the plurality of channels. The removable seal 142 is disposed over the openings 134 of the plurality of channels. The removable seal 142 may be vacuum-sealed to the nipple body 122, or held in place by an adhesive. The seal 142 is used to avoid contamination of the nipple body 122 or the plurality of channels during the distribution process, while in storage, and before being placed into the mouth of a user.

Other embodiments contemplate a removable seal (not shown) that is disposed about the entire oral fluid delivery device 120. Similar to above, the removable seal may be vacuum sealed around the nipple body 122, or held in place by an adhesive such that the seal is used to avoid contamination of the nipple body 122 or the plurality of channels before being placed into the mouth of a user.

In at least one embodiment, the plurality of channels 130 or the venturi meter (shown in FIG. 4) of the oral fluid delivery device 120 are configured to prolong the administration time by 175% to 500% when compared to typical baby nipples, and in other embodiments by more than 200% to 425% when compared to typical baby nipples, and in yet other embodiments by more than 250% to 300% when compared to typical baby nipples.

For example, the plurality of channels 130 or the venturi meter could be configured such that 2.0 ml of at least 24% sucrose solution experiencing a relatively constant oral suction pressure of 0.3 psi results in a dispense time of approximately nine minutes. As mentioned above, conventional nipples tested under the same conditions had a dispense time between six seconds and three minutes. In further embodiments, the oral fluid delivery device 120 may have a varied number of channels, in which the plurality of channels 130 have a varied diameter and/or length. The plurality of channels 130 or the venturi meter, regardless of the physical dimensions or structure, may be seen as a passive valve mechanism slowing the amount of fluid delivered. The flow could also be slowed based on the density of a honeycomb, or sponge-like structure (not shown). The flow could also be varied to result in a similar slowing of fluid delivery based on the size and dimensions of the venturi meter. And the microchannels, honeycomb, or sponge-like structures, or the venturi meter may also be optimized for flow based on the viscosity and properties of the fluid. In one embodiment, the oral fluid delivery device 120 may have between forty five and seventy five channels 130, in which each of the plurality of channels 130 has a diameter less than one hundred microns, and a length less than six mm. For instance, in certain embodiments the diameter of the channels can be thirty to eighty microns, and in other embodiments forty-five to sixty-five microns. Moreover in certain embodiments the length of the channels may be one to five mm, and in other embodiments two to three mm. Similarly the flow could be altered in one embodiment based on altering the size of the throat or angles of the connecting pipes within the venturi meter.

In one embodiment of the first section 124 of the oral fluid delivery device 120, the plurality of channels 130 are formed in a non-linear configuration (not shown).

In at least one embodiment of the oral delivery device 120, the channels 130 include a honeycomb structure (not shown). Where any suitable honeycomb structure can be used, in at least one embodiment, the honeycomb structure comprises a series of layered sheets (not shown), with each sheet defining a grid of open cells (not shown), and with the sheets being aligned slightly offset from each other such that the open cells of each layered sheet intersect with the open cells of adjacent layered sheets. In other embodiments, honeycomb type structures comprising a grid or matrix of intersecting cells, as opposed to layered sheets, are used.

In another embodiment of the oral fluid delivery device 120, the plurality of channels 130 are formed from a sponge (not shown). The sponge has an upper surface defining ostia (not shown) as the openings 134 for the plurality of channels, a lower surface defining ostia adjacent the frangible seal (shown in FIG. 8), and a volumetric body (not shown) defining a plurality of pores, such that upper surface ostia are in fluid communication with the lower surface ostia through the pores. The sponge may be formed of synthetic or natural material.

In one embodiment of the oral fluid delivery device 120, the fluid reservoir 136 is removable from the nipple body 122. Once removed, a replacement fluid reservoir (not shown) which can be defined by a replacement frangible seal and a replacement second section or can consist of a fluid reservoir with a piston (not shown) may be inserted. The replacement fluid reservoir may be filled with a replacement fluid. This cartridge style replacement of pre-filled replacement fluid reservoirs with or without a venturi meter (shown in FIG. 3) or a plurality of channels would allow the nipple body 122 to be reused with an easy filling operation. In another embodiment, the replacement reservoir could be pre-filled manually by the caregiver prior to placing it back in the device. The various embodiments could involve a replacement reservoir could consist of the entire nipple member or the fluid reservoir alone, or the fluid reservoir with a piston, or a fluid reservoir and channels or the fluid reservoir and honeycomb, sponge-like structure, or venturi meter within the nipple member or base member. It should also be noted that the replacement fluid is made up of the same kind of solutions or medicants as fluid 138 mentioned above.

With reference to FIG. 10, an oral fluid delivery device is illustrated in accordance with another embodiment and is referenced by numeral 220. The oral fluid delivery device 220 includes a container 274 that defines a supplementary fluid reservoir 276. In this embodiment, the container 274 is attached to the bottom of a second section 226 of the nipple body 222. A frangible seal 228 is ruptured to enable a plurality of channels 230 to be in fluid communication with a fluid reservoir 236 of the nipple body 222 and the supplementary fluid reservoir 276 of the container 274. In at least one embodiment, upon rupturing the frangible seal 228, the fluid reservoir 236 would contain a fluid (not shown) that would become mixed with the fluid in the supplementary fluid reservoir and both the fluid reservoir 236 and supplementary fluid reservoir 276 would be in fluid communication with each other and the plurality of channels 230. In at least one other embodiment the fluid reservoir 236 would contain a fluid that would not mix with the contents of the container 274, by having sets of channels 230 in fluid communication with the fluid reservoir 236 and separate sets of channels (not shown) in fluid communication with the supplementary fluid reservoir 276. The container may be any fixed volume vessel such as, but not limited to, a baby bottle or cup. The supplementary fluid reservoir 276 may contain any fluid such as, but not limited to, milk, water, juice, or soda. In an alternate version of this embodiment (not shown), the frangible seal can be avoided as the nipple member containing a venturi meter with or without a fluid reservoir could be attached to the container 274 containing a supplementary fluid reservoir 276.

Another embodiment of the oral fluid delivery device 220 includes a syringe (not shown) that defines the supplementary fluid reservoir 276. In at least one embodiment, the syringe is attached to the bottom of the second section 226 of the nipple body 222. The frangible seal 228 is ruptured to enable the plurality of channels 230 to be in fluid communication with the fluid reservoir 236 of the nipple body and the supplementary fluid reservoir 276 of the syringe. In another embodiment, the frangible seal could also be avoided, and the nipple which could contain a plurality of channels, honeycomb or sponge-like structure, or a venturi meter could be directly connected to the syringe with or without a filter in between (not shown).

Referring to FIGS. 8-10, the frangible seal 128, 228 of the oral fluid delivery device 120, 220 is ruptured by twisting the nipple body 122, 222 or base member. In other embodiments, the oral fluid delivery device 120, comprises a base 180 (shown in FIG. 9) attached to the second section 126 of the nipple body 122 and a piercing button (not shown) disposed on the base 180, wherein the frangible seal 128 is ruptured by the piercing button. In yet further embodiments, the frangible seal 128, 228 is ruptured by forces on the frangible seal 128, 228 imparted during the pulling, pushing or squeezing of the nipple body 122, 222 or base member 180. In another embodiment, the seal could be ruptured via forces on the seal due to pulling, squeezing, pushing on the nipple or base member. In yet another embodiment, the frangible seal could be avoided by having a piston within the reservoir.

In an alternate embodiment of the invention, the oral fluid delivery device 120, 220 contemplates the fluid 138 being held entirely within the passage containing the plurality of channels 130, 230 or the venturi meter (not shown). The nipple body 122, 222 has a passage containing either the venturi meter or the plurality of channels 130, 230 and openings 134, 234 of the plurality of channels or one opening for the plurality of channels. The fluid resides within the passage, and a removable seal (shown in FIG. 9) is placed over the opening or openings 134, 234 of the passage with the venturi meter or plurality of channels 130, 230 such that the seal should be removed to release the fluid. The seal may be vacuum-sealed around the nipple body 122, 222 or held in place by an adhesive or other suitable means. The seal is used to prevent contamination of the nipple body 122, 222, or the passage containing the venturi meter or plurality of channels 130, before being placed into the mouth of a user, and is used to retain the fluid.

An oral fluid delivery device 120, 220 with the passage containing either the venturi meter or a plurality of channels 130 being pre-filled with fluid (thus having no fluid reservoir) is used with the same kinds of fluids as listed above, maintain the same kind of flow rates as listed above, have the same kind of physical dimensions and structures as listed above, and attach to the same kind of vessels as listed above.

In one embodiment, the oral fluid delivery device 120, 220 is configured as a baby pacifier (such as that of FIG. 1) and the plurality of channels 130 are formed as micro-channels (shown in FIG. 8).

Other embodiments of the device 120, 220 that are configured as the baby pacifier include the plurality of channels 130 as being honeycomb in structure, as disclosed above.

Referring to FIG. 11, another alternate embodiment of the oral fluid delivery device 320 is contemplated having a removable compartment 384. At least one of the alternate embodiments has a replacement plurality of channels 386, a replacement fluid disposed within the replacement plurality of channels, and a replacement seal (not shown) over the plurality of channels. In another embodiment, the removable compartment 384 contains the plurality of channels 386 separated by the frangible seal from the replacement fluid reservoir. In this style replacement, the replacement seal would not be necessary, as the frangible seal would be present within the compartment. The replacement seal is removable to release the replaceable fluid. This cartridge style replacement of pre-filled replacement plurality of channels would allow the oral fluid delivery device 320 to be reused with an easy filling operation. It should also be noted that the replacement fluid is made up of the same kind of solutions or medicants as fluid mentioned above. In yet another embodiment, the replacement cartridge would contain only the fluid reservoir or the fluid reservoir with a piston or the fluid reservoir with a piston and a venturi meter (not shown).

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An oral fluid delivery device comprising:
a body having base and a nipple extending from the base, the nipple having at least one channel projecting therethrough;
a fluid reservoir having a proximal end secured to the base to form an integrated unit; and
a valve disposed between the fluid reservoir and the channel for restricting fluid flow through the channel.

2. The device of claim 1 wherein the valve comprises an orifice plate having an aperture formed therethrough with an inner diameter of 0.5 to 0.7 millimeters for restricting fluid flow from the device to 0.05 to 0.56 milliliters per minute when the nipple is subjected to a suction pressure of approximately 0.3 pounds per square inch.

3. The device of claim 1 further comprising a fluid disposed within the fluid reservoir, wherein the fluid reservoir contains less than 5.0 milliliters of the fluid and the ratio of fluid within the fluid reservoir in milliliters to flow rate through the valve in milliliters per minute is between 1:0.10 and 1:0.09.

4. The device of claim 1 wherein the device is configured as a disposable assembly without any removable components.

5. The device of claim 1 wherein the valve is disposed over an opening formed through the proximal end of the fluid reservoir.

6. The device of claim 5 wherein the fluid reservoir further comprises a distal end with a vent hole formed therethrough for equalizing pressure within the fluid reservoir.

7. The device of claim 1 further comprising a piston disposed within the fluid reservoir and adapted for translating relative to the base corresponding to the amount of fluid contained within the fluid reservoir.

8. The device of claim 7 wherein the piston engages an inner periphery of the fluid reservoir for forming a seal.

9. The device of claim 8 further comprising at least one o-ring disposed about an outer periphery of the piston for engaging the inner periphery of the fluid reservoir and forming the seal.

10. The device of claim 8 further comprising a wiper-seal disposed about an outer periphery of the piston for engaging the inner periphery of the fluid reservoir and forming the seal.

11. A packaging assembly comprising:
a receptacle for receiving the device of claim 1; and
a projection extending from the receptacle and through an opening formed in a distal end of the nipple for preventing fluid from flowing from the device.

12. The packaging assembly of claim 11 wherein the receptacle further comprises a contoured end for receiving the nipple and an opening formed opposite the contoured end, and wherein a top is secured about the receptacle opening for enclosing the device within the receptacle.

13. The device of claim 1 wherein the at least one channel further comprises at least forty channels, each channel having an inner diameter less than one hundred microns.

14. The device of claim 1 further comprising a frangible seal for constraining the fluid within the fluid reservoir until the seal is ruptured.

15. The device of claim 1 further comprising a removable seal disposed over a distal end of the nipple.

16. The device of claim 1 wherein the base is configured for attaching to a supplementary fluid reservoir.

17. A pacifier comprising:
a body having a base and a nipple extending from the base, the nipple having at least one channel projecting therethrough;
a fluid reservoir having a proximal end secured to the base to form an integrated unit, and a distal end with a vent hole formed therethrough for equalizing pressure within the fluid reservoir, the fluid reservoir being in fluid communication with the at least one channel; and
a piston disposed within the fluid reservoir and adapted for translating relative to the base corresponding to the amount of fluid contained within the fluid reservoir.

18. The pacifier of claim 17 further comprising a valve disposed between the fluid reservoir and the channel for restricting fluid flow through the channel.

19. A method for assembling a pacifier comprising:
providing a fluid reservoir having a proximal end with an opening formed therethrough;
disposing a valve over the fluid reservoir opening; and
molding a body having a base and a nipple over the fluid reservoir, to form an integrated unit without any removable components.

20. The method of claim 19 further comprising injecting fluid through the nipple and valve into the fluid reservoir.
